(19) United States
(12) Patent Application Publication
(10) Pub. No.: US 2012/0263021 A1
(43) Pub. Date: Oct. 18, 2012

(54) Pest Repellent System and Device

(75) Inventor: Ray Connell, Wickham (NSW) (AU)

(73) Assignee: PLUG IN PEST FREE AUSTRALIA PTY LTD, Wickham (AU)

(21) Appl. No.: 13/502,034

(22) PCT Filed: Oct. 15, 2010
(86) PCT No.: PCT/AU2010/001366

§ 371 Date: Jul. 2, 2012

(30) Foreign Application Priority Data
Oct. 16, 2009 (AU) 2009905046

(51) Int. Cl. A01M 29/22

(52) U.S. Cl. 367/139

(57) ABSTRACT

An improved pest repellent system which results in altering the existing electromagnetic field in the electricity supply of a building by inducing a phase shift in the supply by applying a voltage to a highly inductive coil or coils in a timed pattern which pattern is offensive to pests said system comprising providing: a device including a frame; at least one highly inductive coil appropriately wired within the frame and able to generate the altered electromagnetic field; a solid-state circuit for controlling supply voltage to the coil(s), a timing means of controlling the timed pattern; and optionally an earthing wire passing through the coil(s) to conduct said altered electromagnetic field to the environment around the device; wherein said timed pattern comprises a first period where the voltage is pulsed on and off through the coil(s) resulting in a phase shift in the alternating current of the supply and a second period of equal duration to the first period where supply of voltage to the coil(s) is paused; wherein the device is operated to repel pests.

### FIELD OF THE INVENTION

The present invention relates to the control of pests. In particularly it relates to the control of animal pest such as mice, rats and cockroaches but also extends to other pests.

### BACKGROUND

Control of pests is of increasing importance especially in heavily populated areas of the world where pests such as rats and cockroaches can reach very high numbers. There is a growing awareness that the use of chemicals to control pests is not desirable because such chemicals may potentially contaminate the environment and cause problems to humans and other animals. Thus it is desirable to control pests without resorting to chemical means.

A number of devices such as that disclosed in Australian patent number 664508 have been proposed to control pests however these devices have not proved entirely satisfactory. This has in part been due to their construction which has in some cases involved fragile components and lack of compliance with various safety standards.

The above references to and descriptions of prior proposals or products are not intended to be, and are not to be construed as, statements or admissions of common general knowledge in the art in Australia.

### SUMMARY

The present invention relates to a combination of features which results in a surprisingly improved pest repellent system and device. Specifically the invention relates to improved pest repellent system which results in altering the existing electromagnetic field in the electricity supply of building by inducing a phase shift in that electricity supply by applying a voltage to a highly conductive coil or coils in a timed pattern which pattern is offensive to pests said system comprising providing: a device including a frame;

at least one highly inductive coil appropriately wired within the frame and able to generate the altered electromagnetic field;

a solid-state circuit for controlling supply voltage to the coil(s),

a timing means of controlling the timed pattern; and optionally

an earthing wire passing through the coil(s) to conduct said altered electromagnetic field to the environment around the device;

wherein said timed pattern comprises a first period where the voltage is pulsed on and off through the coil(s) resulting in a phase shift in the alternating current of the supply and a second period of equal duration to the first period where supply of voltage to the coil(s) is paused;

wherein the device is operated to repel pests.

The terms “altering the existing electromagnetic field in the electricity supply of a building” and “altered electromagnetic field” refer to the creation of an electromagnetic field different from that which is normally associated with the electricity supply of the building. All buildings powered by an electricity supply have an electromagnetic field created by electricity and alteration of this electromagnetic field creates an environment which is offensive to pests.

The term “building” refers to the built environment such as a commercial or industrial building, includes factories, office buildings, high-rise buildings, restaurants and domestic buildings such as houses and sheds, farm buildings, chicken runs, and other buildings to house animals and the like.

The term “highly inductive coil or coils” refers to refers to a coil of suitable material, commonly copper which is able to induce the electrical current to produce an altered electromagnetic force (EMF).

The term “offensive to pests” means that the vibration is irritating, intolerable or otherwise disagreeable to pests making them wish to escape from the vibration. It has been proven by scientific testing that the altered field created by the present invention causes reduced food and water intake in rats in the vicinity and causes them to live elsewhere.

The frame or support may be of any suitable material able to house or support the highly inductive coil such as metal plate material or plastic.

The term “a solid-state circuit” refers to the circuit capable of controlling the introduction of the voltage into the device so as to allow the coils(s) to generate the altered EMF.

The term “a timing means for controlling the timed pattern” refers to a means for switching the AC voltage on and off such as an Opto coupler, triac or the like. In a preferred aspect the first period (on/off period) and the second period (pause period) is for between about 136.5 seconds and about 163.8 seconds. Preferably each period is for 136.5 seconds. Alternatively preferably each period is for 163.8 seconds.

In a preferred aspect the invention comprises two coils wired in a series. In another preferred aspect to the two coils are wired in parallel. The coils are preferably in the range of about 17 to about 5000 ohms. Preferably the ohms are about 17.2, 2950 or 4850.

The invention also provides an improved pest repellent device which when in use results in altering the existing electromagnetic field in the electricity supply by inducing a phase shift in that electricity supply of a building by applying a voltage to a highly conductive coil or coils in a timed pattern which pattern is offensive to pests said device comprising:

a frame or support;

at least one highly inductive coil appropriately wired within the frame and able to generate the altered electromagnetic field;

a solid-state circuit for controlling supply voltage to the coil(s),

a timing means of controlling the timed pattern; and, optionally

an earthing wire passing through the coil(s) to conduct said altered electromagnetic field to the environment around the device;

wherein said timed pattern comprises a first period where the voltage is pulsed on and off through the coil(s) resulting in a phase shift in the alternating current of the supply and a second period of equal duration to the first period where supply of voltage to the coil(s) is paused.

### DETAILED DESCRIPTION OF THE ILLUSTRATIVE EMBODIMENTS OF THE INVENTION

The preferred embodiments of the invention are described with reference to the following non limiting drawings:

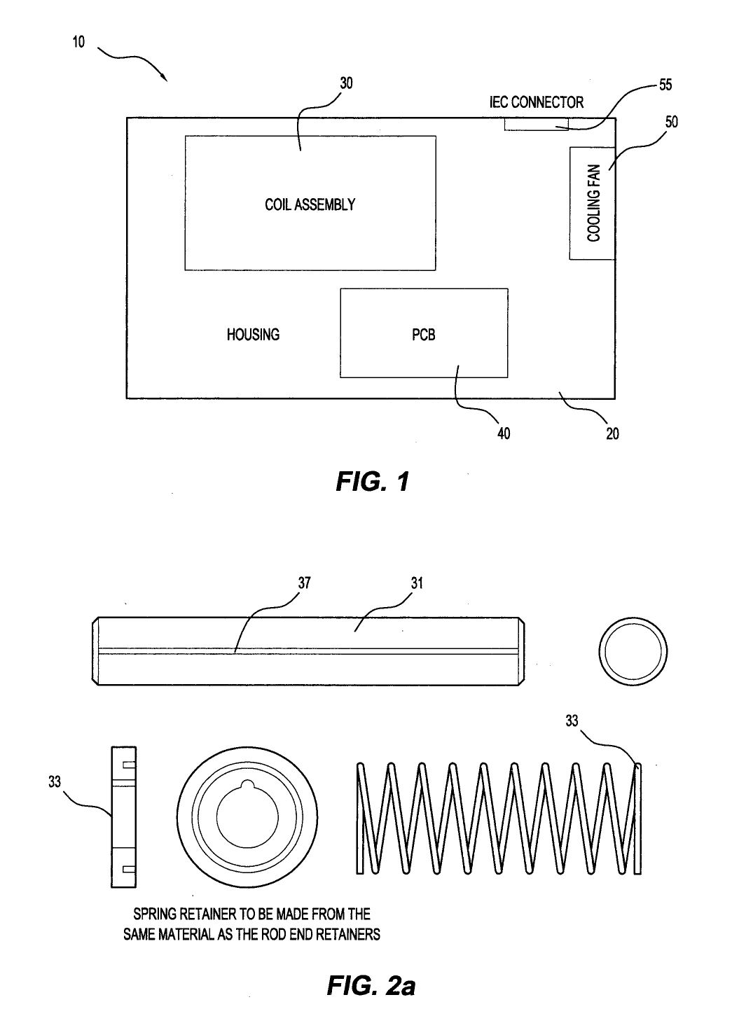

FIG. 1 is a schematic drawing of a unit of the present invention suitable for commercial situations.

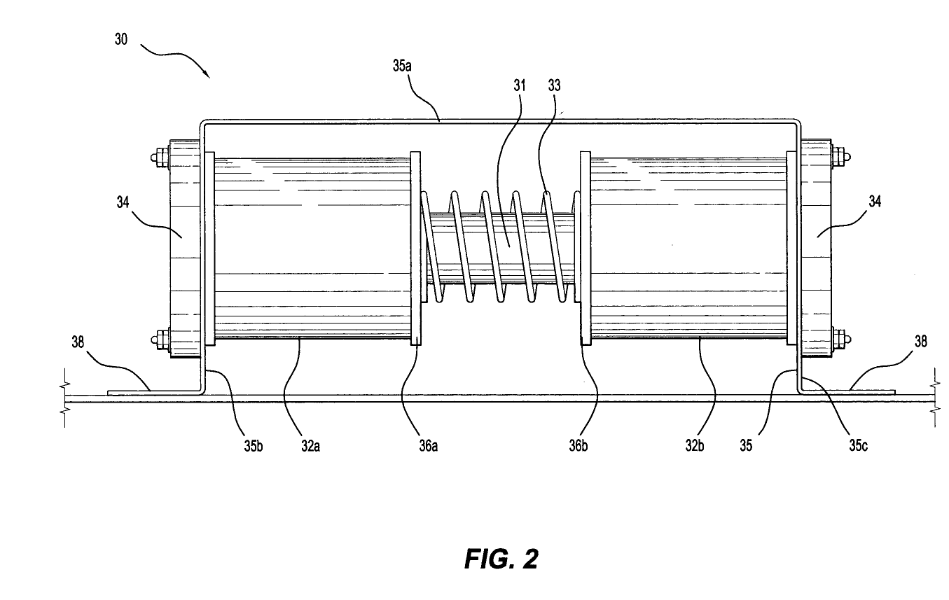

FIG. 2 is a front view photograph of the coil assembly of the commercial unit.

FIG. 2A shows the coil assembly and its various components.

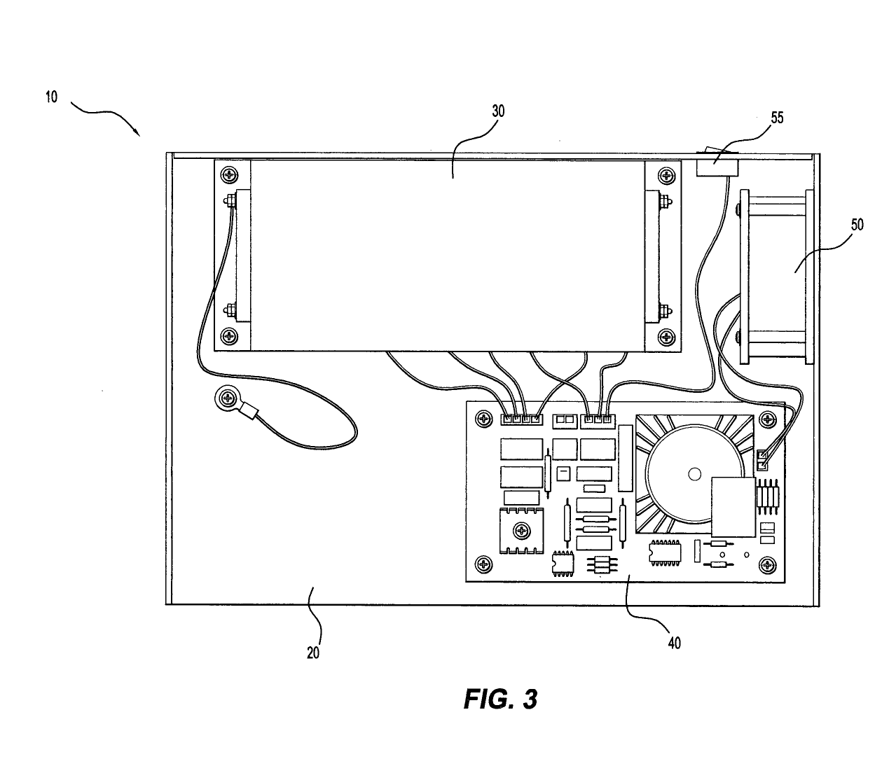

FIG. 3 is a plan view photograph of the commercial unit showing various components.

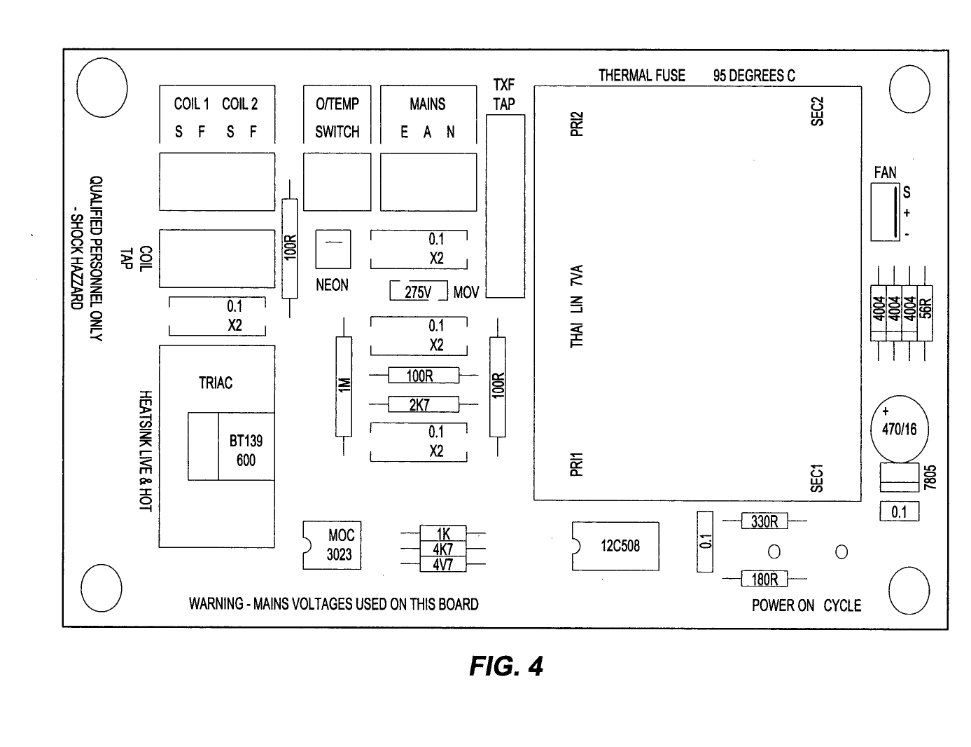

FIG. 4 is a schematic diagram of the printed circuit board (PCB) of the commercial unit.

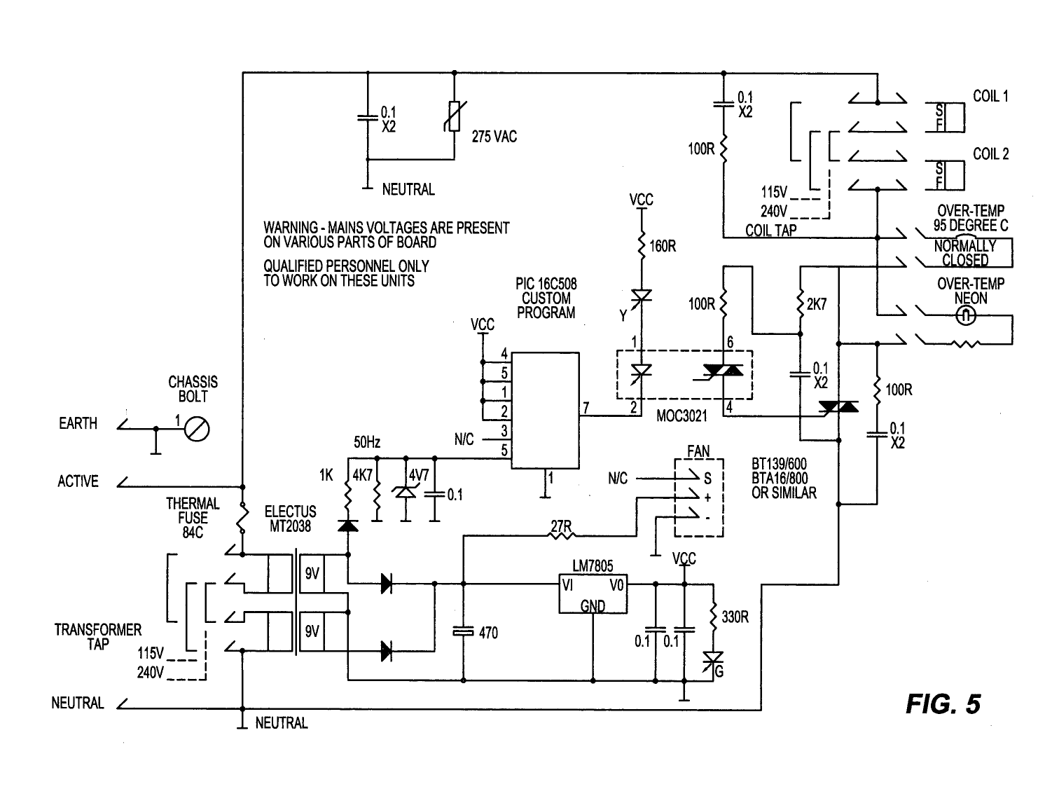

FIG. 5 is a schematic diagram showing the wiring of the circuit of the commercial unit.

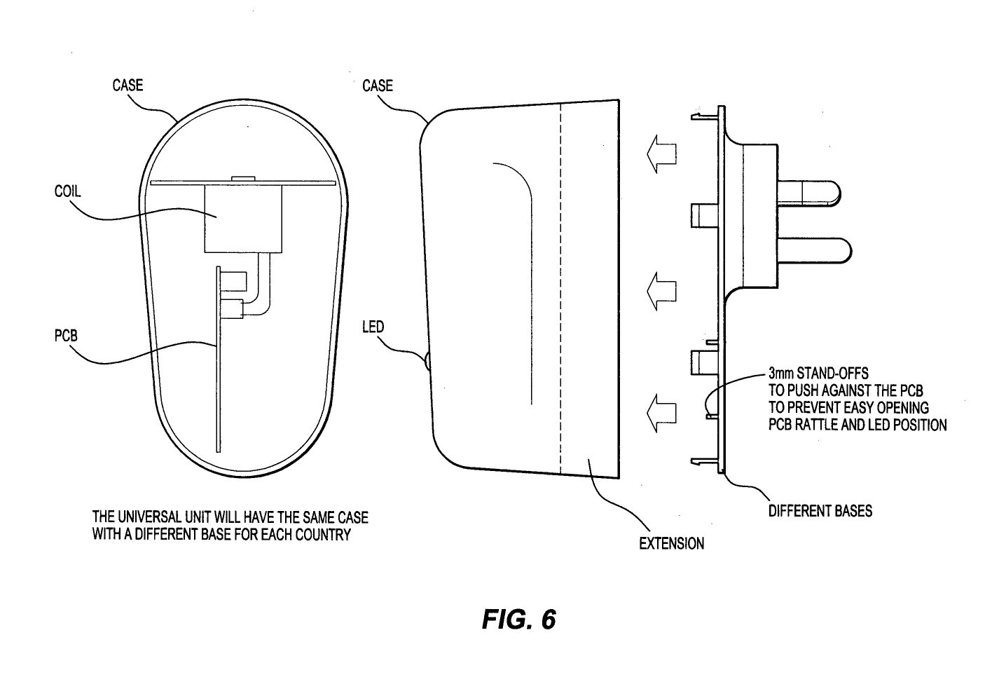

FIG. 6 is a schematic diagram of a unit suitable for a domestic situation.

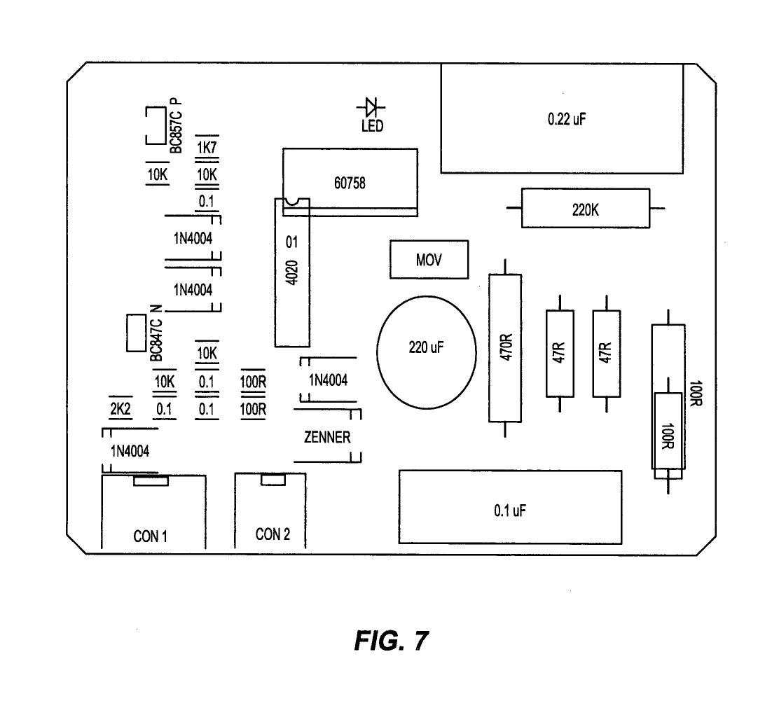

FIG. 7 is a representation of the PCB of the domestic unit.

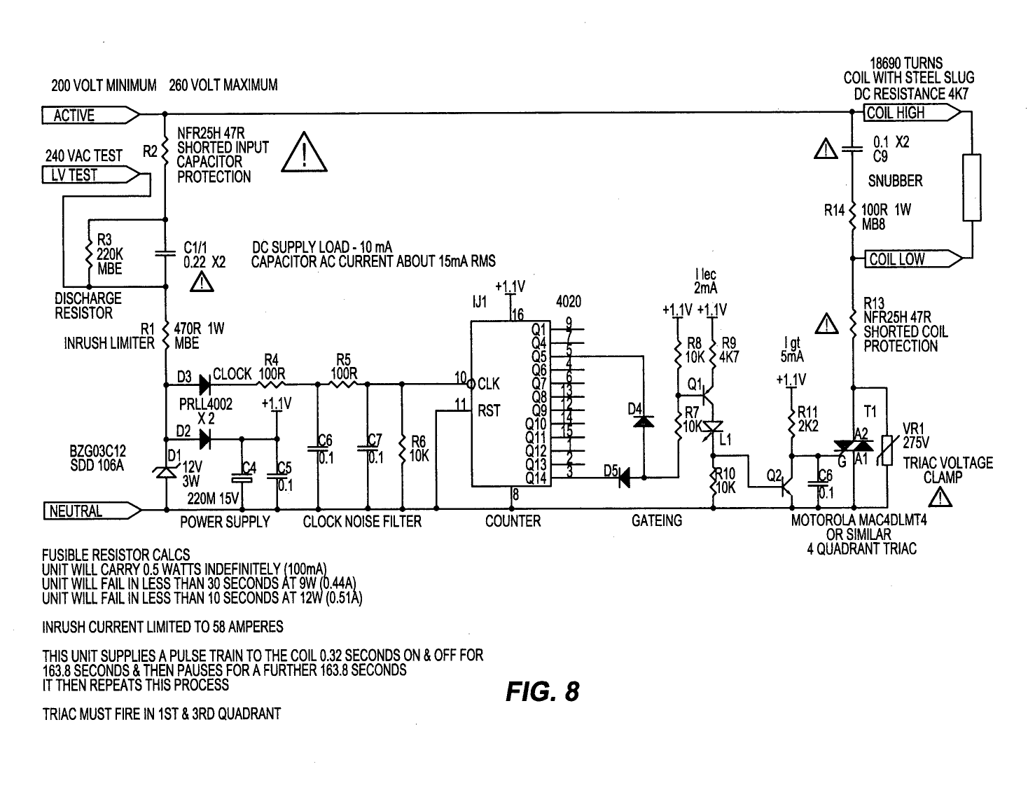

FIG. 8 years a schematic diagram showing the wiring for the circuit of the domestic unit.

The device of the invention in a form suitable for commercial use (the commercial unit) 10 comprises a generally rectangular housing 20 made of interconnected panels of sheet metal or other suitable material. Located within housing 10 are coil assembly 30, printed circuit board (PCB) 40, cooling fan 50 and IEC connector 55. Rectangular housing 10 is about 30×20×10 cm in size.

Coil assembly 30 comprises frame or support 35 which is essentially suitably folded metal plate comprising top 35a, ends 35b and 35c and legs 38 for bolting the frame onto housing 20. Located between ends 35b and 35c is steel rod 31 and coils 32a and 32b. These coils are essentially solenoids comprised of wound copper wire of 0.475 mm diameter and have 1750 turns. Coils 32a and 32b are 10 Ohm when measured in parallel and are spaced apart from each other at either end of rod 31. The coils are of an appropriate diameter to be offset from rod 31. Anti-knocking Spring 33 is located between the coils coaxial to rod 31. Spring 33 is made of 2 mm galvanized steel wire and has 10 turns. Rod 31 is held in place by appropriate rod end retaining members 34. The two coils 32a and 32b act like a solenoid when AC voltage is applied to them. The result is an attraction and repulsion between the coils. The coils cannot physically move apart any further as they are held by the frame 35. The two coils are prevented from touching by spring 33 which is held in place by spring end retainers 36a and 36b. Spring 33 is used to take up the slack and reduce the knocking sound when the coils are energized.

Rod 31 comprises slot 37 in which earth wire 60 is embedded. One end of the earth wire 60 is connected to frame 35 and the other end is connected to the earth wire of the IEC connector and thereby, when in use, to the earth wire of the mains power outlet. Mains current is fed into coils 32a and 32b. As the voltage builds up and recedes in the coils, this creates an electromagnetic force which is transferred to rod 31 which in turn induces a small voltage (in the millivolts range, approximately 90 mV) into the wiring system of the building via earth lead or line 60 thereby transferring the frequency of the device to the building. This switching of the coils yields a momentary phase change in the active line in the building. The earth line 60 is connected to the rod 31 inside the coils 32a and 32b. This injects a small signal onto the earth throughout the building.

The solid-state circuit is shown in schematic form in FIG. 5. The mains voltage enters via the IEC connector and the active line which powers the circuit is run to the coils via an over temperature protection device to a triac (BT139/600 for example) and then to the neutral. The unit is controlled via a power supply of 5V to a microcontroller in the form of PIC16C508 which generates a pattern of pulses onto the Opto coupler which in turn switches the triac. This then controls the voltage to the coil assembly.

It has been surprisingly found that and on/off period and a pause period of equal duration is very effective in repelling pests. Further a pulse of 0.32 seconds on/off for a period of 136.5 second followed by an equal pause period is highly offensive to pests such as rats, cockroaches and the like. Such a timing regime is suitable for

Australia. For the USA, the same pulse is contemplated however the on/off period is for 163.8 seconds followed by a pause period equal time.

It has also been surprisingly found that the combination of a robust antiknock spring, the retainer sleeves and cooling fan provided a durable and long-lasting unit. It should be noted that other inductive insect control devices are poorly designed and constructed, with components stacked on top of each other and added on the bottom of the PCB. Some boards even have burn marks around the main coil which is mounted directly to the PCB.

The domestic unit is much smaller than the commercial unit and has a plastic housing that is similar in appearance to a computer mouse with dimensions of about 10×7×4 cm. Differences between the units are summarized below. The domestic unit is operated on the same pulse pattern as the commercial unit but has a different coil assembly and does not have a cooling fan as it runs on 7 W compared to the much higher energy use of the commercial unit. This unit is wired for easy installation of different IEC connectors so that it can be manufactured for use in different countries. FIG. 6 shows a schematic representation of the domestic device which contains a single coil of much higher inductance than the commercial coil assembly. Specifically the single coil comprises 18890 turns of copper wire with a DC resistance of 4850 Ohms to function on a 240V/50 Hz power supply. Alternatively the coil comprises 11450 turns of copper wire with a DC resistance of 2950 Ohms for a 110V/60 Hz power supply for the USA, for example. The coil is retained by an aluminum plate (not shown) which slots into the plastic housing. The plastic housing functions as the coil frame support. The single non ferrous aluminum heat sink acts as a spacer between the coil and the surclip (not shown) at the end of the coil. This reduces the inductance of the coil therefore more current flows through it. The design and mounting of the coil assembly including the single non ferrous aluminum heat sink results in a better heat flow from the coil, a lower coil working temperature and a greater magnetic field than in other designs. The end result is that the device runs cooler and produces more of a phase shift in the active. The timing pattern is achieved by injecting the 50/60 Hz AC signal into a pin on the 4020 IC. The domestic unit does not make use of the earth signal injection system of the commercial unit but is nonetheless very effective in repelling pests. The solid state circuit for the domestic unit is shown in schematic form in FIG. 8.

TABLE 1
Summary of features

| | Commercial unit | Domestic |
|---|---|---|
| Coil | two | one |
| Coil size | 4Au Series/US parallel | Au OD 22.0 mm/US OD |
| | 1 mm | 18.4 |
| Number of turns | 1750 | Au 18890/US 11450 |
| Ohms of coil | around 17.2 each | Au 4850 Ohms/US 2950 |
| Frequency of | Au 50 Hz/US 60 Hz | Au 50 Hz/US 60 Hz |
| vibration | | |
| Length of on/off | Au 163.8 sec US 136.5 | Au 163.8 sec US 136.5 |
| | sec | sec |
| Length of pause | Au 163.8 sec US 136.5 | Au 163.8 sec US 136.5 |
| | sec | sec |

1. A pest repellent system which results in altering the existing electromagnetic field in the electricity supply of a building by inducing a phase shift in the supply by applying a voltage to a highly inductive coil or coils in a timed pattern which pattern is offensive to pests said system comprising providing:
a device including a frame;
at least one highly inductive coil appropriately wired within the frame and able to generate the altered electromagnetic field;
a solid-state circuit for controlling supply voltage to the coil(s),
a timing means of controlling the timed pattern; and optionally an earthing wire passing through the coil(s) to conduct said altered electromagnetic field to the environment around the device;
wherein said timed pattern comprises a first period where the voltage is pulsed on and off through the coil(s) resulting in a phase shift in the alternating current of the supply and a second period of equal duration to the first period where supply of voltage to the coil(s) is paused;
wherein the device is operated to repel pests.

2. The system of claim the pulse is 0.32 seconds on and 0.32 off.

3. The system of claim 1 wherein the first period is 136.5 to 163.8 seconds and the second period is 136.5 to 163.8 seconds.

4. A pest repellent device which when in use results in altering the existing electromagnetic field in the electricity supply by inducing a phase shift in the supply of a building by applying a voltage to a highly inductive coil or coils in a timed pattern which pattern is offensive to pests said device comprising:
a frame or support;
at least one highly inductive coil appropriately wired within the frame and able to generate the altered electromagnetic field;
a solid-state circuit for controlling supply voltage to the coil(s),
a timing means of controlling the timed pattern; and optionally
an earthing wire passing through the coil(s) to conduct said altered electromagnetic field to the environment around the device;
wherein said timed pattern comprises a first period where the voltage is pulsed on and off through the at least one coil resulting in a phase shift in the alternating current of the supply and a second period of equal duration to the first period where supply of voltage to the at least one coil is paused.

5. The device of claim 4 wherein the pulse is 0.32 seconds on and 0.32 off.

6. The device of claim 5 wherein the first period is 136.5 to 163.8 seconds and the second period is 136.5 to 163.8 seconds.

7. The system of claim 1 comprising two coils wired in a series or two coils wired in parallel of 17.2 Ohms.

8. The system of claim 1 comprising a single coil of 4850 Ohms or 2950 Ohms.

9. (canceled)

10. The device of claim 4 comprising two coils wired in a series or two coils wired in parallel of 17.2 Ohms.

11. The device of claim 4 comprising a single coil of 4850 Ohms or 2950 Ohms.
